(19) United States
(12) Patent Application Publication
(10) Pub. No.: US 2011/0081137 A1
(43) Pub. Date: Apr. 7, 2011

(54) MANUFACTURING EQUIPMENT AND MANUFACTURING METHOD

(75) Inventor: Shin Masuda, Miyagi (JP)

(73) Assignee: ADVANTEST CORPORATION, Tokyo (JP)

(21) Appl. No.: 12/574,635

(22) Filed: Oct. 6, 2009

(51) Int. Cl. A21B 1/02

(52) U.S. Cl. 392/416; 29/592.1

(57) ABSTRACT

There are provided a manufacturing apparatus and a manufacturing method for manufacturing a substrate having a dielectric film, including a heat treatment apparatus that subjects a substrate on which a raw material containing composite oxide is applied, to heat treatment and crystallization in an atmosphere containing oxygen in a volume ratio of 20% or above under pressure of an atmospheric pressure or above. The manufacturing apparatus may manufacture a substrate having a ferroelectric film used as an optical control device. The heat treatment apparatus may include: a chamber that keeps, in the atmosphere, the substrate on which the raw material is applied; and a pressure adjusting section that adjusts a pressure of the atmosphere in the chamber to a predetermined value for a predetermined time period during heat treatment.

### BACKGROUND

1. Technical Field

The present invention relates to a manufacturing apparatus and a manufacturing method.

2. Related Art

Conventionally, lead zirconate titanate (composite oxide of PbZrTiO system, hereinafter referred to as “PZT”) is known to have a high dielectric constant, high piezoelectricity, and ferroelectric characteristics. It is also known to be able to manufacture transparent lead lanthanum zirconate titanate (composite oxide of PbLaZrTiO system, hereinafter referred to as “PLZT”), by adding La (lanthanum) to PZT. In making a thin film by a ferroelectric material such as PZT and PLZT, there have been such problems as polarization fatigue phenomenon or deterioration in polarization characteristics due to crystal defect attributable to vaporization of lead (Pb) and oxygen deficiency, to deteriorate and compromise the device characteristics.

So as to restrain the polarization fatigue phenomenon or the like, a method has been proposed to insert, between PZT and the electrode, an oxide electrode such as iridium oxide as a buffer layer. The method is disclosed in Takashi Mihara, et. al., “Polarization Fatigue Characteristics of Sol-Gel Ferroelectric Pb(Zr_{0.4}Ti_{0.6})O₃ Thin-Film Capacitors”, Japanese Journal of Applied Physics, Japan, July 1994, Vol. 33, Part 1 No. 7A, pp. 3996-4002, for example. Moreover, for manufacturing a capacitor used for an electronic device such as FeRAM, a ferroelectric thin-film manufacturing process has been proposed to pressurize a raw material containing composite oxide by 2 atmospheric-pressures or more, and to subject the result to heat treatment in an atmosphere containing oxygen in a volume ratio of 10% or below. The process is disclosed in Japanese Patent Application Publication No. 2004-207304, for example.

Also refer to Japanese Patent Application Publications Nos. S63-202910, 2004-131812, and 2006-154145, and Taisuke Furukawa, et. al., “Fatigueless Ferroelectric Capacitors with Ruthenium Bottom and Top Electrodes Formed by Metalorganic Chemical Vapor Deposition”, Japanese Journal of Applied Physics, Japan, March 2005, Vol. 44, No. 12, pp. L378-L380.

However, in operating the device, the voltage applied to PZT leaks to the buffer layer, preventing PZT from receiving sufficient voltage. Moreover, in the process according to Japanese Patent Application Publication No. 2004-207304, crystallization is conducted by heat treatment performed in a low-oxygen concentration atmosphere and high temperatures, which tends to cause the ferroelectric film to lack oxygen. Therefore, according to the method disclosed in Japanese Patent Application Publication No. 2004-207304, it has been difficult to manufacture a ferroelectric thin-film exhibiting favorable ferroelectric characteristics while preventing cracks as well as restraining deterioration of morphology.

### SUMMARY

Therefore, it is an object of an aspect of the innovations herein to provide a manufacturing apparatus and a manufacturing method, which are capable of overcoming the above drawbacks accompanying the related art. The above and other objects can be achieved by combinations described in the independent claims. The dependent claims define further advantageous and exemplary combinations of the innovations herein.

According to an aspect related to the innovations herein, exemplary manufacturing apparatus and manufacturing method for manufacturing a substrate having a dielectric film, include a heat treatment apparatus that subjects a substrate on which a raw material containing composite oxide is applied, to heat treatment and crystallization in an atmosphere containing oxygen in a volume ratio of 20% or above under pressure of an atmospheric pressure or above.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a system configuration example of a manufacturing apparatus 100 according to the present embodiment, together with a substrate 10.

FIG. 2 shows an operational flow of a manufacturing apparatus 100 according to the present embodiment.

FIG. 3 is an overview of a process of making a ferroelectric film on a substrate 10 according to the present embodiment.

FIG. 4 shows an AFM image of a PZT film manufactured by a manufacturing apparatus 100 according to the present embodiment.

FIG. 5 shows an X-ray diffraction pattern of a PLZT film manufactured by a manufacturing apparatus 100 according to the present embodiment.

FIG. 6 shows an X-ray characteristic of a PLZT film manufactured on a single crystalline substrate by a manufacturing apparatus 100 according to the present embodiment.

FIG. 7 shows a P-E hysteresis characteristic of a PZT film manufactured by a manufacturing apparatus 100 according to the present embodiment.

FIG. 8 shows a polarization fatigue characteristic of a PZT film and of a PLZT film manufactured by a manufacturing apparatus 100 according to the present embodiment.

FIG. 9 shows an electrooptic property of a PLZT film manufactured by a manufacturing apparatus 100 according to the present embodiment.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention. The same or similar elements may occasionally be provided with the same reference numeral, with the related description thereof omitted.

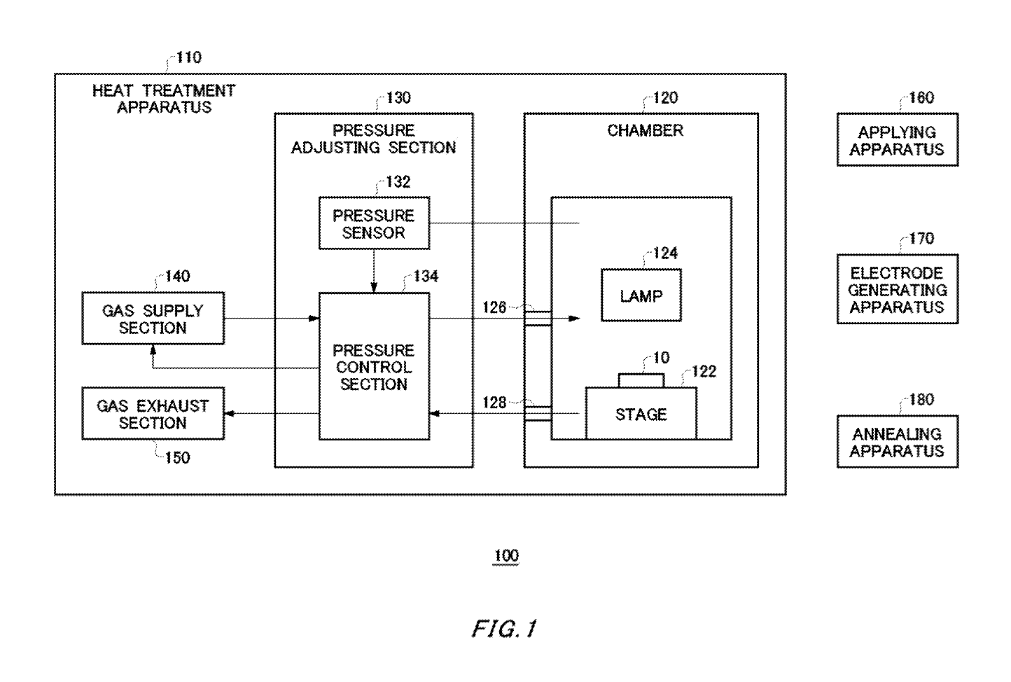

FIG. 1 shows a system configuration example of a manufacturing apparatus 100 according to the present embodiment, together with a substrate 10. The manufacturing apparatus 100 manufactures a substrate 10 having a dielectric film. The dielectric film may be a ferroelectric film made of PZT, PLZT, or the like. The dielectric film may also be compound oxide of bismuth lanthanum titanate system (BiLaTiO system, hereinafter referred to as “BLT”), bismuth titanate system (BiTiO system, hereinafter referred to as “BIT”), and bismuth strontium tantalite system (SrBiTaO system, hereinafter referred to as “SBT”).

The manufacturing apparatus 100 may manufacture a substrate 10 having a ferroelectric film used as an optical control device, or may manufacture a substrate 10 having a dielectric film used as a capacitor or a piezoelectric material such as a piezoelectric actuator. The manufacturing apparatus 100 includes a heat treatment apparatus 110, an applying apparatus 160, an electrode generating apparatus 170, and an annealing apparatus 180.

The heat treatment apparatus 110 subjects a substrate 10 on which a raw material containing composite oxide is applied, to heat treatment in an atmosphere containing 20% or more oxide in volume ratio under pressure of an atmospheric pressure or above. The heat treatment apparatus 110 may be a rapid thermal annealing apparatus for annealing the substrate 10 in a lamp heating method called RTP (Rapid Thermal Process). The heat treatment apparatus 110 includes a chamber 120, a pressure adjusting section 130, a gas supply section 140, and a gas exhaust section 150.

The chamber 120 keeps the substrate 10 on which a raw material is applied, in the above-described atmosphere. The chamber 120 includes a stage 122, a lamp 124, a gas inlet 126, and an exhaust outlet 128. The stage 122 retains the substrate 10. The lamp 124 may be a healing lamp such as a halogen lamp, or a heating light source such as laser or LED.

The chamber 120 includes at least one gas inlet 126 and an exhaust outlet 128 for exhausting the chamber 120. The gas inlet 126 is connected to the gas supply section 140 via the pressure adjusting section 130. Likewise, the exhaust outlet 128 is connected to the gas exhaust section 150 via a pipe and the pressure adjusting section 130.

The pressure adjusting section 130 adjusts the pressure of the atmosphere in the chamber 120 to a predetermined value for a predetermined time period during heat treatment. The pressure adjusting section 130 adjusts the flow rate of the gas supplied to the chamber 120 and/or the flow rate of the gas exhausted from the chamber 120, according to the pressure measured in the chamber 120, so as to maintain the inside of the chamber 120 to have a predetermined atmosphere. The pressure adjusting section 130 includes a pressure sensor 132 and a pressure control section 134.

The pressure sensor 132 measures the atmospheric pressure in the chamber 120. The pressure sensor 132 may be a device for converting a pressure of a gas into an electric signal using a pressure sensitive device or the like. The pressure sensor 132 may be provided in the chamber 120, or may be provided in a pipe connected to the chamber 120, the pipe having the same atmosphere as the chamber 120.

The pressure control section 134 adjusts the amount of the atmosphere to be exhausted from the chamber 120, according to the atmospheric pressure measured by the pressure sensor 132. For example, a pressure adjusting valve may be provided in a pipe connecting the chamber 120 with the gas exhaust section 150, so that the pressure control section 134 can switch open/close of the pressure adjusting valve to adjust the pressure within the chamber 120.

More specifically, when the atmospheric pressure measured by the pressure sensor 132 is lower than the target atmospheric pressure, the pressure control section 134 may close the pressure adjusting valve to reduce the amount of exhausted gas. When the atmospheric pressure measured by the pressure sensor 132 is higher than the target atmospheric pressure, the pressure control section 134 may open the pressure adjusting valve to increase the amount of exhausted gas. Here, the pressure adjusting valve may be included in a case that contains the pressure sensor 132.

The pressure control section 134 may further adjust the amount of the atmosphere to be introduced into the chamber 120, according to the atmospheric pressure measured by the pressure sensor. For example, a pressure adjusting valve may be provided in a pipe connecting the chamber 120 with the gas supply section 140, so that the pressure control section 134 can control open/close of the pressure adjusting valve to adjust the atmosphere within the chamber 120.

More specifically, when the atmospheric pressure measured by the pressure sensor 132 is lower than the target atmospheric pressure, the pressure control section 134 may open the pressure adjusting valve to increase the amount of supplied gas. When the atmospheric pressure measured by the pressure sensor 132 is higher than the target atmospheric pressure, the pressure control section 134 may close the pressure adjusting valve to reduce the amount of supplied gas. Here, the pressure adjusting valve may be included in a case that contains the pressure sensor 132.

In addition, the pressure control section 134 may control the pressure of the gas supplied by the gas supply section 140, thereby adjusting the amount of the atmosphere within the chamber 120. When there are a plurality of gas supply sections 140 in a manufacturing apparatus 100, the pressure control section 134 may control the supply flow rate of each of the plurality of gas supply sections 140, so as to adjust the amount of the atmosphere within the chamber 120.

The gas supply section 140 supplies gas to the chamber 120. The gas supplied by the gas supply section 140 may be an oxygen gas, a nitrogen gas, and/or an argon gas. There may be a plurality of gas supply sections 140 according to the type of gases used in the manufacturing process. The gas supply section 140 may adjust the flow rate of supplied gas, and may adjust the flow rate of gas according to a control signal transmitted from the pressure control section 134. The gas exhaust section 150 exhaust gas from the chamber 120. The gas exhaust section 150 may be a rotary pump, a diffuser pump, a vacuum pump such as a turbo-molecular pump, or a combination of them.

The applying apparatus 160 applies a raw material containing a compound oxide, to a substrate 10. Here, the raw material may be a sol-gel material that contains at least one of Pb, Ba, and Bi. The applying apparatus 160 may be a spin coater adopting a spin coating method, or a spray coater adopting a spray coating method.

The electrode generating apparatus 170 generates an electrode on a dielectric film formed by repeating application of a raw material and crystallization. The electrode generating apparatus 170 may be a sputtering apparatus that causes atoms or ions to impinge on a surface of a solid in a high speed, which causes atoms constituting the solid to be emitted to the space and then be deposited on the substrate 10 thereby forming a thin film. The electrode generating apparatus 170 also may be a deposition apparatus that deposits metals or oxides on a surface of the substrate 10.

The annealing apparatus 180 dries and thermally decomposes the material applied to the substrate 10. The annealing apparatus 180 may be a hot plate, a baking oven, a furnace, or a lamp annealer. The annealing apparatus 180 may anneal the substrate 10 having a dielectric film on which an electrode is generated.

The manufacturing apparatus 100 having the above-described exemplary configuration is able to perform heating quickly by controlling the atmosphere of the substrate 10. Accordingly, the manufacturing apparatus 100 is able to perform rapid thermal annealing on the substrate 10 on which a raw material containing composite oxide is applied, under a predetermined gas concentration or a predetermined gas pressure. The following explains an exemplary manufacturing flow according to which the manufacturing apparatus 100 manufactures a ferroelectric thin film.

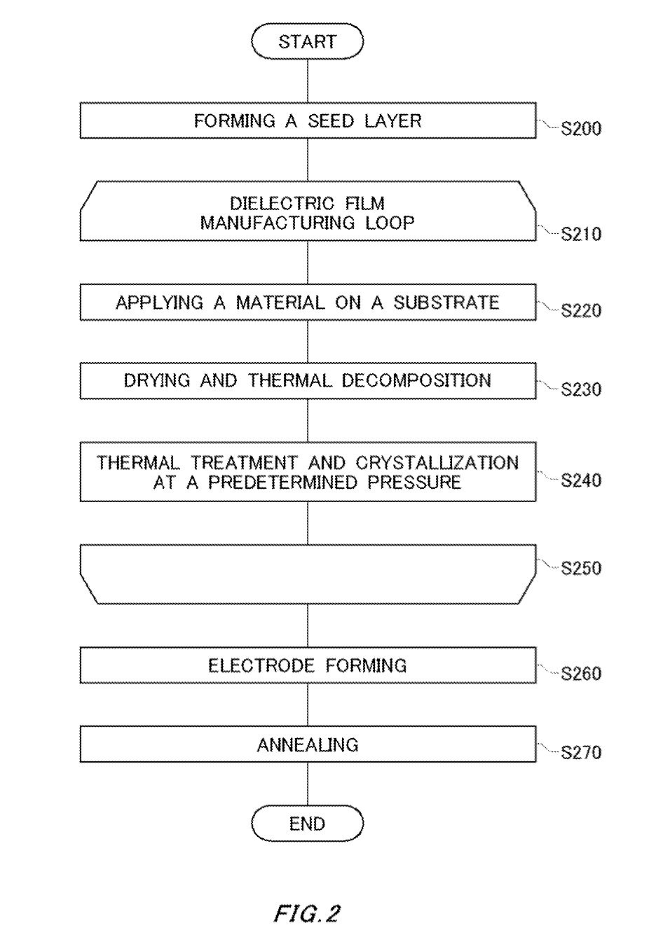

FIG. 2 shows an operational flow of a manufacturing apparatus 100 according to the present embodiment. The manufacturing apparatus 100 forms a seed layer on the substrate 10 (S200). The seed layer is formed as a result of the applying apparatus 160 applying a material of the seed layer on the substrate 10, and the annealing apparatus 180 drying and thermally decomposing the result. The seed layer may be formed between the substrate 10 and the ferroelectric film, to function as a buffer layer for alleviating the lattice match difference therebetween.

The manufacturing apparatus 100 forms a PbTiO₃ thin film, for example using a PbTiO₃ sol-gel material as a material of a seed layer. The annealing apparatus 180 may dry a material applied on the substrate 10 at the temperature of 100 degrees centigrade, for example. In addition, the annealing apparatus 180 may thermally decompose a material applied on the substrate 10 at the temperature of 300 degrees centigrade, for example.

Next, in forming a ferroelectric thin film, the manufacturing apparatus 100 repeats Step S210 through Step S250 which constitute a loop for manufacturing a dielectric film, until a predetermined film thickness is obtained. The manufacturing apparatus 100 applies, on the substrate 10, a sol-gel material according to a ferroelectric thin film to be formed, using the applying apparatus 160 (S220). The manufacturing apparatus 100 performs drying and thermal decomposition on an applied material using the annealing apparatus 180 under substantially the same condition used in forming the sccd layer (S230).

The manufacturing apparatus 100 subjects the substrate 10 to a high-temperature heat treatment, to crystallizes the applied material, using the heat treatment apparatus 110 (S240). Here, the heat treatment apparatus 110 may raise the temperature in the chamber 120 to a temperature at which the ferroelectric thin film is crystallized, under a condition in which the pressure of the atmosphere in the chamber 120 is adjusted to a predetermined pressure. In an example of forming a AZT thin film, the heat treatment apparatus 110 may raise the temperature up to a 600-700 degrees centigrade which is about the temperature at which a PZT thin film is crystallized, for crystallizing the PZT thin film.

The heat treatment apparatus 110 may perform heat treatment and crystallization in an atmosphere containing oxygen in a range of volume ratio between 20% and 100%, inclusive. The heat treatment apparatus 110 may perform heat treatment and crystallization in an atmosphere containing oxygen in a volume ratio of about 21% which is just about the atmospheric air. The heat treatment apparatus 110 supplies oxygen from the gas supply section 140, to control the oxygen atmosphere in the chamber 120 by the pressure adjusting section 130.

The heat treatment apparatus 110 may raise the temperature in the chamber 120 to a temperature at which a ferroelectric thin film is crystallized at a temperature increase speed of 1-15 degrees centigrade per second, under a condition in which the pressure of the atmosphere within the chamber 120 is adjusted to a predetermined pressure. For example, the heat treatment apparatus 110 may also raise the temperature in the chamber 120 to a temperature at which a ferroelectric thin film is crystallized, by 2-10 degrees centigrade per second. In this case, the heat treatment apparatus 110 may perform heat treatment while the pressure adjusting, section 130 controls the pressure within the chamber 120.

In this case, the pressure adjusting section 130 may adjust the pressure of the atmosphere in the chamber 120 to a predetermined pressure in the range between 0.1 MPa and 0.3 MPa during a predetermined period of time. For example, the pressure adjusting section 130 may adjust the pressure of the atmosphere in the chamber 120 to a predetermined pressure in the range between 0.1 MPa and 0.2 MPa. For example, the aforementioned predetermined period of time may be a period of heating or a period of time after the heating and until the temperature returns back to a normal temperature.

As stated above, the heat treatment apparatus 110 can quickly raise the temperature of the substrate 10 by rapid thermal annealing, and cause the pressure in the chamber 120 to be a predetermined level, thereby preventing scatter of Pb which is a material having a high vapor pressure. In addition, the heat treatment apparatus 110 decreases lack of a material substance (e.g. Pb) in the crystallized ferroelectric thin film and oxygen, by means of performing the treatment in a short period of time (e.g. raising the temperature at a temperature increase speed of 2-10 degrees centigrade per second).

In addition, the heat treatment apparatus 110 can compensate for the oxygen in the oxygen atmosphere by performing heat treatment in an atmosphere containing oxygen in a volume ratio of 20% or above, even when there is oxygen deficiency in the ferroelectric thin film due to heat treatment. Accordingly, the heat treatment apparatus 110 can form a crystal of a ferroelectric thin film having favorable crystal characteristics and favorable morphology.

The applying apparatus 160, the annealing apparatus 180, and the heat treatment apparatus 110 may repeat, a plurality of number of times, the processing of applying a raw material on a substrate having a dielectric film crystallized by the heat treatment apparatus 110, and performing heat treatment and crystallization to the result in the above-described atmosphere. The manufacturing apparatus 100 forms a ferroelectric thin film having a predetermined film thickness by repeating crystallization.

The manufacturing apparatus 100 may form an electrode on a ferroelectric thin film having a predetermined film thickness using the electrode generating apparatus 170 (S260). The electrode generating apparatus 170 may form a predetermined metal electrode and/or oxide electrode by vacuum evaporation method or sputtering. After the formation of the electrode, the manufacturing apparatus 100 may utilize the thermal treatment apparatus 110 to perform rapid thermal annealing in the oxygen atmosphere of a predetermined pressure (S270). In this case, the thermal treatment apparatus 110 may set, to a predetermined adequate value, such conditions as pressure, oxygen atmosphere, heating temperature, and temperature increase speed.

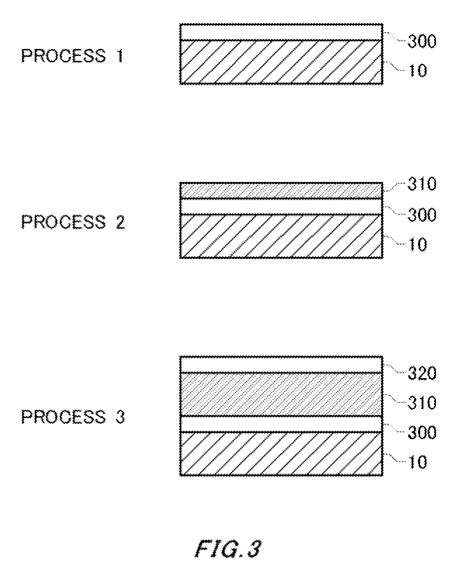

FIG. 3 is an overview of a process of making a ferroelectric film on a substrate 10 according to the present embodiment. The substrate 10 may be a single crystalline substrate of a substrate having a metal electrode. For example, the substrate 10 may be a single crystalline substrate such as MgO, SrTiO₃, and Al₂O₃ (sapphire), or may be a substrate made by forming a metal film on a Si substrate such as Pt/TiOx/SiO₂/Si.

First, the manufacturing apparatus 100 forms a seed layer 300 on the substrate 10 (Process 1). The seed layer 300 maybe a thin film of PbTiO₃ for example. For example, the manufacturing apparatus 100 forms a seed layer 300 by applying a PbTiO₃ sol-gel material on the substrate 10 and heating the result. The seed layer 300 alleviates the difference in lattice match between the ferroelectric thin film formed in the next process and the substrate 10, endowing the ferroelectric thin film with a favorable crystal characteristic.

Next, the manufacturing apparatus 100 forms a ferroelectric thin film layer 310 on a seed layer 300 (Process 2). For example, when the ferroelectric thin film layer 310 is PZT, the manufacturing apparatus 100 applies a PZT sol-gel material on the substrate 10, and performs thereto drying and thermal decomposition. The ferroelectric thin film layer 310 is crystallized by the heat treatment apparatus 110 after drying and thermal decomposition.

After obtaining a predetermined film thickness of ferroelectric thin film layer 310 by repetition of Process 2, the manufacturing apparatus 100 generates an electrode layer 320 on the ferroelectric thin film layer 310 (Process 3). The electrode layer 320 may be formed in an intended form by photolithography. After the electrode generating apparatus 170 has generated the electrode layer 320, the manufacturing apparatus 100 performs rapid thermal annealing again.

The manufacturing apparatus 100 performs Process 1 through Process 3 in the above-stated operational flow, thereby manufacturing the substrate 10 having a dielectric film. The manufacturing apparatus 100 of the present embodiment example is able to crystallize a ferroelectric film in an oxygen atmosphere having a predetermined pressure, thereby obtaining an oxide thin film crystal having a favorable crystal characteristic and favorable surface morphology. The following explains reasons why such a favorable thin film crystal is obtained.

The manufacturing apparatus 100 according to the present embodiment example performs heat treatment in an increased pressure which is equal to the atmospheric pressure or above, and in an atmosphere containing oxygen in a volume ratio of 20% or above. Therefore, the increased pressure helps restrain the evaporation of a raw material such as Pb, Bi, or Ba, and at the same time the high-concentration oxygen atmosphere helps prevent oxygen deficiency that tends to be caused in high-temperature annealing.

For the purpose of avoiding oxygen deficiency, the manufacturing apparatus 100 may also perform annealing at comparatively low temperature under increased pressure. However, if crystallized at lower temperatures than the crystallization temperature, a ferroelectric material such as PZT is known to cause formation of a layer of paraelectrics called “pyrochlore phase” in a thin film, to deteriorate the ferroelectric characteristic. Therefore, the manufacturing apparatus 100 can obtain an adequate thin film crystal by performing crystallization under high temperature conditions such as about the crystallization temperature in an oxygen atmosphere in an increased pressure.

In addition, the manufacturing apparatus 100 maintains the pressure within the chamber 120 to be a predetermined constant value during a high-temperature heat treatment process. Accordingly, the manufacturing apparatus 100 may restrain the pressure fluctuation in the chamber 120 that tends to happen when for example the temperature in the chamber 120 is increased from the normal temperature to the high temperature. In other words, the manufacturing apparatus 100 can have the pressure fluctuation which is an environmental condition of the chamber 120 to be constant in the crystallization process of the ferroelectric thin film, to realize crystallization with favorable reproducibility.

As stated above, the manufacturing apparatus 100 can form an adequate thin film crystal with favorable reproducibility, and can therefore manufacture a ferroelectric thin film having an intended film thickness without a crack and without deteriorating the morphology by repetition of a single process. Moreover, the manufacturing apparatus 100 adequately crystallizes the ferroelectric thin film, and can therefore adequately form an upper electrode without a buffer layer. Accordingly, an adequate electric field can be applied to a ferroelectric thin film, and can therefore make use of the characteristic of the adequately manufactured ferroelectric thin film.

In the above-stated embodiment example, the manufacturing apparatus 100 has a heat treatment apparatus 110, an applying apparatus 160, an electrode generating apparatus 170, and an annealing apparatus 180. Instead, the manufacturing apparatus 100 may include the applying apparatus 160 inside the heat treatment apparatus 110. The manufacturing apparatus 100 may cause the heat treatment apparatus 110 to perform the annealing executed in the annealing apparatus 180.

Accordingly, the manufacturing apparatus 100 is able to manufacture a ferroelectric thin film having an intended film thickness by having the heat treatment apparatus 110 and the electrode generating apparatus 170. The manufacturing apparatus 100 according to the present embodiment example can manufacture a favorable ferroelectric thin film in a very simple process, namely application of a material and annealing, thereby realizing a small apparatus size.

In addition, the manufacturing apparatus 100 may be a single apparatus by incorporating the electrode generating apparatus 170 into the heat treatment apparatus 110. For example, the chamber 120 for rapid thermal annealing may also be used to perform vacuum evaporation method or sputtering executed by the electrode generating apparatus 170. Accordingly, the manufacturing apparatus 100 may be practically the heat treatment apparatus 110 itself, which can manufacture a ferroelectric thin film of an intended film thickness in a smaller space.

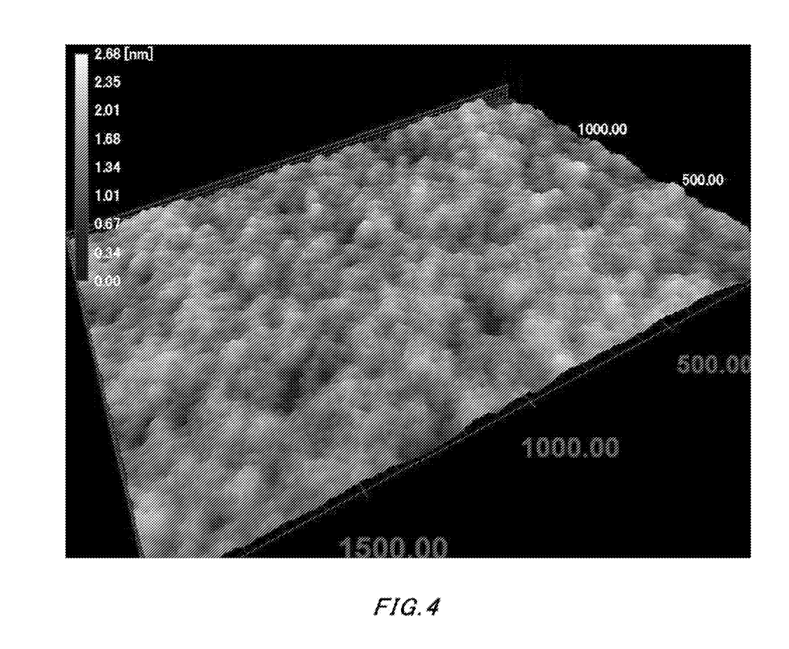

FIG. 4-FIG. 9 show an exemplary characteristic of an actually manufactured ferroelectric film. The manufacturing apparatus 100 uses PZT (Zr/Ti=52/48) and PLZT (La/Zr/Ti=8/65/35) adjusted to the stoichiometric composition, as a sol-gel solution. Here, the manufacturing apparatus 100 uses a sol-gel solution containing an amount of Pb that is 10 mol % to 20 mol % greater than the stoichiometric composition, taking into consideration scatter of Pb during a heat treatment stage.

The manufacturing apparatus 100 performed Process 1 through Process 3 in the above-described operational flow, to manufacture a PZT film and a PLZT film. Here, the manufacturing apparatus 100 performed rapid thermal annealing under a constant pressure of 0.2-0.3 MPa, to perform crystallization, thereby manufacturing a PZT film and a PLZT film having a thickness of 3 μm.

FIG. 4 shows an AFM (atomic force microscope) image of a PZT film manufactured by a manufacturing apparatus 100 according to the present embodiment. The drawing shows that the manufacturing apparatus 100 has manufactured a ferroelectric film of very flat surface morphology having an average surface roughness of 0.4 nm.

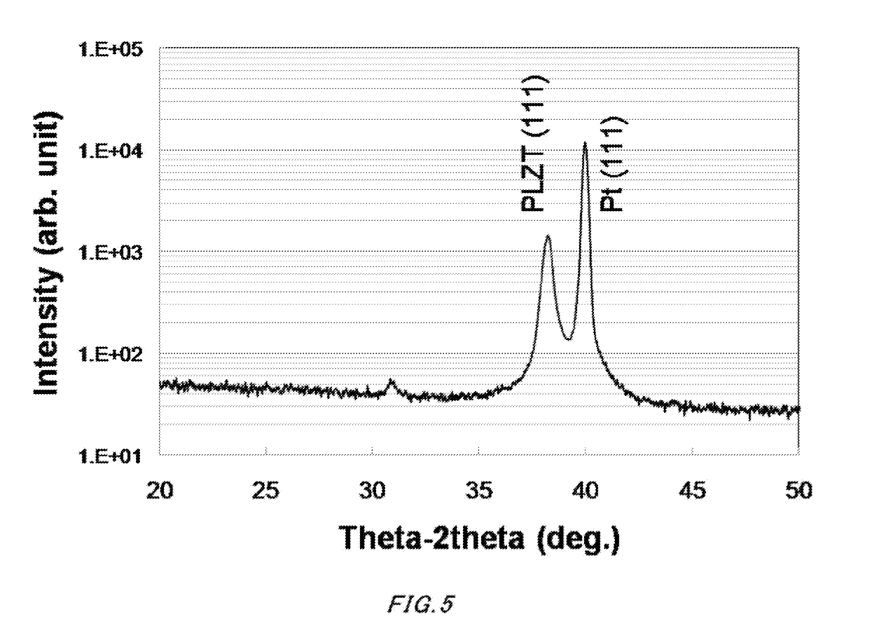

FIG. 5 shows an X-ray diffraction pattern of a PLZT film manufactured by a manufacturing apparatus 100 according to the present embodiment. The manufacturing apparatus 100 used a Pt/SiO₂/TiOₓ/Si substrate as a substrate 10, and manufactured a PLZT film thereon. It is known that, when a pyrochlore phase is formed in a dielectric film, a peak peculiar to the X-ray diffraction pattern is generated. In this example, however, no such peak has been observed, which proves that the manufacturing apparatus 100 has formed a favorable ferroelectric. In addition, no peak other than those corresponding to the PLZT (111) plane is observed, and so the manufacturing apparatus 100 is proved to have formed a PLZT film having a favorable crystal characteristic.

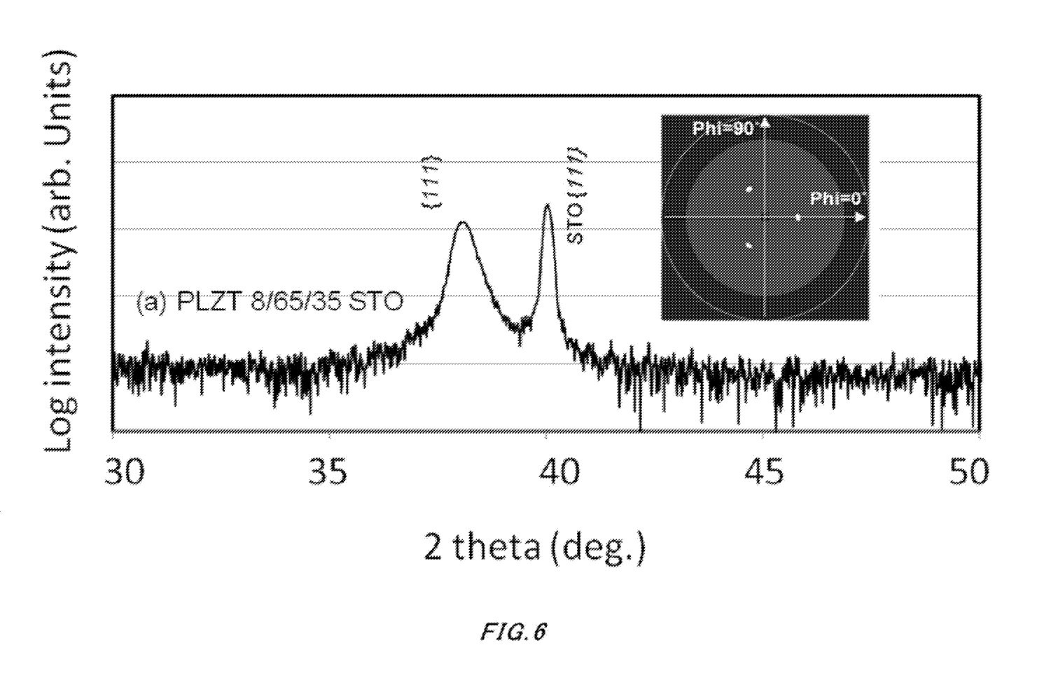

FIG. 6 shows an X-ray characteristic of a PLZT film manufactured on a single crystalline substrate by a manufacturing apparatus 100 according to the present embodiment. The manufacturing apparatus 100 used a SrTiO₃ single crystalline substrate as the substrate 10, and manufactured a PLZT film thereon. No peak of pyrochlore phase is observed in this X-ray diffraction pattern in the drawing, too, which proves that the manufacturing apparatus 100 has formed a favorable ferroelectric. In addition, the symmetric pole figure has been obtained three times, which proves that the manufacturing apparatus 100 has realized favorable orientation of the formed crystal face as well as realizing epitaxial growth in which PLZT film is aligned with the crystal face of the substrate 10.

The above result shows that the manufacturing apparatus 100 has manufactured a ferroelectric film having average roughness of 1 nm or below and a film thickness of 3 μm. In addition, when forming a film on a single crystalline substrate, the manufacturing apparatus 100 has formed an epitaxial film. This proves that the manufacturing apparatus 100 can form an adequate ferroelectric film having a predetermined thickness.

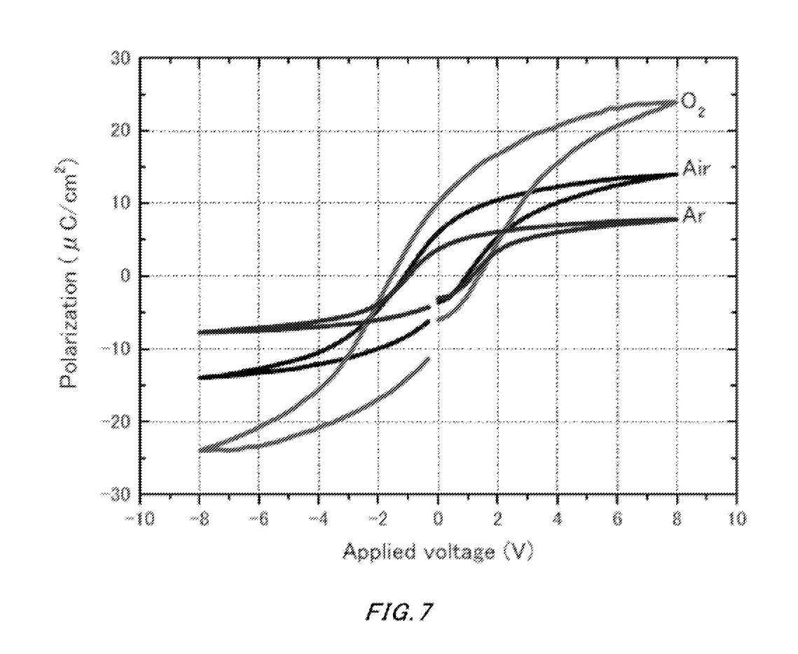

FIG. 7 shows a P-E hysteresis characteristic of a PZT film manufactured by a manufacturing apparatus 100 according to the present embodiment. Here, the P-E hysteresis measurement is used to examine the domain inversion operation of a ferroelectric thin film. In the drawing, the lateral axis corresponds to an applied voltage, and the longitudinal axis corresponds to dielectric polarization. When supplied with a strong direct-current electric field, the domains are aligned in the electric field direction, eventually causing the entire crystal to be aligned as a single domain. When an alternate-current electric field is supplied, the relation between the ferroelectric polarization and the electric field will be a hysteresis curve just as the B-H curve of a ferromagnetic.

The point at which the P-E hysteresis intersects the longitudinal axis in the positive region is referred to as remanet polarization, and the point at which the P-E hysteresis intersects the lateral axis in the positive region is referred to as an coercive electric field. It is known that large remanet polarization and small coercive electric field result in a favorable crystalline orientation. Each of the three hysteresis characteristics in the drawing corresponds to the P-E hysteresis measurement of the dielectric film made from a PZT film when pressuring is performed under argon, oxygen, and air atmospheres respectively.

As a result of comparing the three hysteresis characteristics, the manufacturing apparatus 100 is proved to manufacture a favorable PZT film when pressurizing is performed under an oxygen atmosphere. In addition, when pressurized under an air atmosphere, the resulting PZT film is more favorable than under an argon atmosphere. Since there is about 21% oxygen concentration in the air atmosphere, the result shows that the manufacturing apparatus 100 can manufacture more favorable PZT films as the oxygen concentration in the atmosphere is increased which helps compensate the oxygen deficiency in the PZT film.

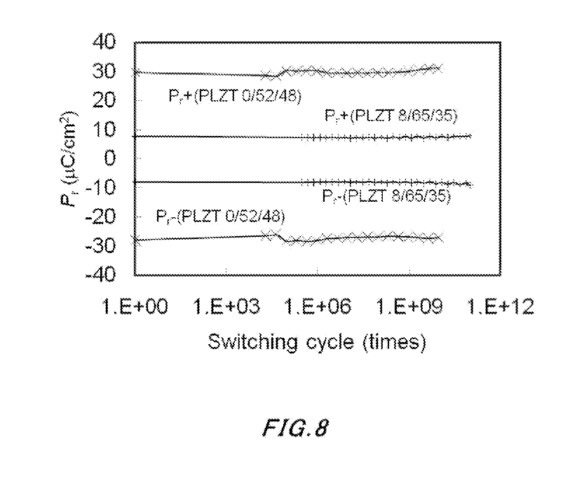

FIG. 8 shows a polarization characteristic of a PZT and PLZT capacitor resulting from forming a PZT film and a PLZT film manufactured by the manufacturing apparatus 100 according to the present embodiment on a Pt/SiO₂/TiOₓ/Si substrate under the above-described condition, and further forming thereon a Pt electrode as an upper electrode. The lateral axis shows the number of times the positive and negative electric fields are applied to the ferroelectric film in a temporarily alternating manner to cause domain inversion and the longitudinal axis indicates a remanet polarization after the domain inversion. Under no pressure, at about 10⁴ through 10⁶ times of domain inversion, polarization fatigue is known to occur in which remanet polarization value is reduced down to about half and the ferroelectric characteristic is deteriorated. This is considered to be attributed to oxygen deficiency of the PZT film.

On the other hand, the PZT film and the PLZT film manufactured using the manufacturing apparatus 100 do not exhibit deterioration in remanet polarization value even after 10¹⁰ or more times of domain inversion. Accordingly, the manufacturing apparatus 100 is proved to restrain oxygen deficiency as well as deficiency due to Pb evaporation either in or on the ferroelectric film, which helps generate a highly reliable ferroelectric thin film.

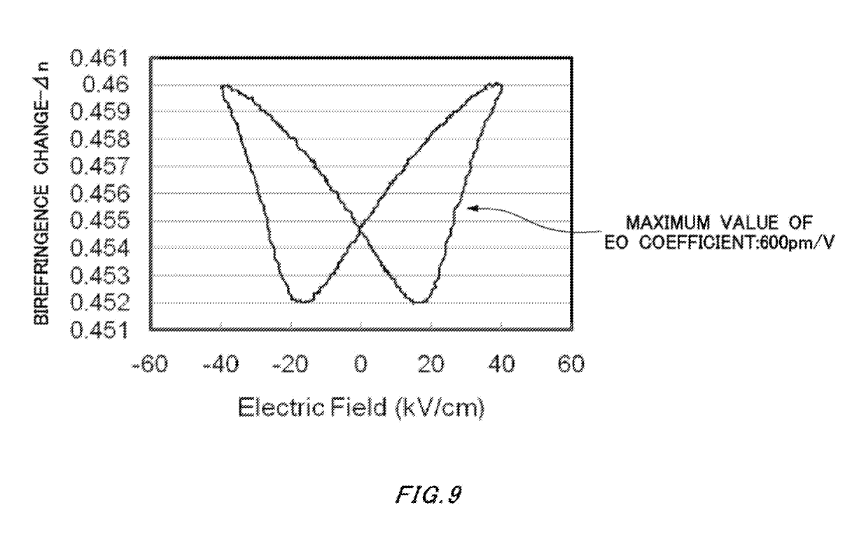

FIG. 9 shows an electrooptic property of a PLZT film manufactured by a manufacturing apparatus 100 according to the present embodiment. The manufacturing apparatus 100 formed a PLZT film on a sapphire substrate as the substrate 10. The electrooptic property is obtained by observing the change in the refraction index of the substance in the applied electric field, and is known to help evaluate the nature of a ferroelectric. The manufacturing apparatus 100 is proved to manufacture a PLZT film having an electro-optic coefficient of 600 pm/V, which is about the same electrooptic property as that of a bulk PLZT crystal. This is the largest of all the PLZT thin film reported so far, which is made possible by the manufacturing apparatus 100.

As proved by the characteristics of the manufactured ferroelectric film, the manufacturing apparatus 100 is able to manufacture a favorable ferroelectric film having a predetermined film thickness without necessitating any special material, complicated configuration, or complicated processing. In addition, the manufacturing apparatus 100 can realize a small apparatus size because it can manufacture a ferroelectric film by repeating application of a material and annealing.

Although some aspects of the present invention have been described by way of exemplary embodiments, it should be understood that those skilled in the art might make many changes and substitutions without departing from the spirit and the scope of the present invention which is defined only by the appended claims.

The operations, the processes, the steps, or the like in the apparatus, the system, the program, and the method described in the claims, the specification, and the drawings are not necessarily performed in the described order. The operations, the processes, the steps, or the like can be performed in an arbitrary order, unless the output of the former-described processing is used in the later processing. Even when expressions such as “First,” or “Next,” or the like are used to explain the operational flow in the claims, the specification, or the drawings, they are intended to facilitate the understanding of the invention, and are never intended to show that the described order is mandatory.

1. A manufacturing apparatus for manufacturing a substrate having a dielectric film, comprising:
a heat treatment apparatus that subjects a substrate on which a raw material containing composite oxide is applied, to heat treatment and crystallization in an atmosphere containing oxygen in a volume ratio of 20% or above under pressure of an atmospheric pressure or above.

2. The manufacturing apparatus according to claim 1, wherein
the manufacturing apparatus manufactures a substrate having a ferroelectric film used as an optical control device.

3. The manufacturing apparatus according to claim 1, wherein
the heat treatment apparatus includes:
a chamber that keeps, in the atmosphere, the substrate on which the raw material is applied; and
a pressure adjusting section that adjusts a pressure of the atmosphere in the chamber to a predetermined pressure for a predetermined time period during heat treatment.

4. The manufacturing apparatus according to claim 3, wherein
the pressure adjusting section includes:
a pressure sensor that measures an atmospheric pressure in the chamber; and
a pressure control section that adjusts an amount of the atmosphere to be exhausted from the chamber, according to the atmospheric pressure measured by the pressure sensor.

5. The manufacturing apparatus according to claim 4, wherein
the pressure control section further adjusts an amount of the atmosphere to be introduced into the chamber, according to the atmospheric pressure measured by the pressure sensor.

6. The manufacturing apparatus according to claim 3, wherein
the heat treatment apparatus raises a temperature in the chamber to a temperature at which the dielectric film is crystallized, under a condition in which the pressure of the atmosphere in the chamber is adjusted to the predetermined pressure.

7. The manufacturing apparatus according to claim 3 wherein
the heat treatment apparatus raises a temperature in the chamber to a temperature at which the dielectric film is crystallized, under a condition in which the pressure of the atmosphere in the chamber is adjusted to the predetermined pressure, at a temperature increase speed of 1-15 degrees centigrade per second.

8. The manufacturing apparatus according to claim 1, wherein
the heat treatment apparatus subjects the substrate on which the raw material is applied, to the heat treatment by lamp annealing.

9. The manufacturing apparatus according to claim 1, wherein
the heat treatment apparatus repeats, a plurality of number of times, processing of applying the raw material on the substrate having a dielectric film crystallized by the heat treatment apparatus and performing heat treatment and crystallization to the result in the atmosphere.

10. The manufacturing apparatus according to claim 9, comprising:
an electrode generating apparatus that generates an electrode on the dielectric film formed by the repetition of application of the raw material and crystallization; and
an annealing apparatus that anneals the substrate having the dielectric film on which the electrode is formed.

11. The manufacturing apparatus according to claim 10, wherein
the annealing apparatus heats and anneals the substrate having the dielectric film on which the electrode is formed, in an atmosphere containing oxygen in a volume ratio of 20% or above under pressure of an atmospheric pressure or above.

12. The manufacturing apparatus according to claim 1, wherein
the raw material is a sol-gel material containing at least one of Pb, Ba, and Bi.

13. A manufacturing method for manufacturing a substrate having a dielectric film, comprising:
applying, to a substrate, a raw material containing composite oxide; and
heat treatment for subjecting the substrate on which the raw material is applied, to heat treatment and crystallization in an atmosphere containing oxygen in a volume ratio of 20% or above under pressure of an atmospheric pressure or above.
